(19) United States
(12) Patent Application Publication
(10) Pub. No.: US 2019/0315253 A1
(43) Pub. Date: Oct. 17, 2019

(54) FOLDABLE BED FOR VEHICLE

(71) Applicant: Rob Thundertentronck, martinsville, VA (US)

(72) Inventor: Rob Thundertentronck, martinsville, VA (US)

(21) Appl. No.: 16/452,125

(22) Filed: Jun. 25, 2019

Related U.S. Application Data
(60) Provisional application No. 62/674,192, filed on May 21, 2018.

(51) Int. Cl. B60N 2/34; B60N 2/30; B60P 3/39

(52) U.S. Cl. CPC B60N 2/345; B60P 3/39; B60N 2/3011

(57) ABSTRACT

A foldable bed, for a vehicle having a front seat, includes a foldable frame, a platform and a plurality of legs configured to each other. The foldable frame includes a plurality of frame parts, and a plurality of latching mechanism coupled to the plurality of frame parts. The latching mechanism is adapted to be latched to the plurality of frame parts to horizontally extend the plurality of frame parts over the front seat at an inclined position. Further, the latching mechanism is adapted to be de-latched to fold the frame parts to be stored in the vehicle. Further, the platform is disposed over the foldable frame. Furthermore, the plurality of legs may be attached to the foldable frame. The of legs extents below the foldable frame to support the frame parts at horizontally extended position over the front seat at the inclined position thereof.

### CROSS REFERENCE TO RELATED APPLICATIONS

The present invention claims priority under 35 United States Code, Section 119 on the provisional application numbered 62/674,192 filed on May 21, 2018, the disclosure of which is incorporated by reference.

### FIELD OF THE INVENTION

The present invention generally relates to vehicle accessories, and, more particularly, a foldable bed for a vehicle having a front seat, and that the foldable bed may be placed over the front seat at its inclined position.

### BACKGROUND OF THE INVENTION

Travel has been one of the favorite activities of human beings. More often than not, travelers like to travel in their personal vehicles, such as car. Further, there are certain jobs that requires long travels, such as truck or bus drivers. Long travels necessitate, the drivers or the passengers of the cars, bus or trucks and so forth to take rest. While rest may refresh the drivers or the passengers of the cars, bus or trucks, but may add expense to the pocket to such drivers or passengers in terms of booking motel or hotel.

Further, while there is additional option for the drivers or the passengers of the cars, bus or trucks and so forth to take rest in the respective vehicles' seat itself, but such option may not provide comfortable rest or sleep and thereby resulting unrest body and mind of the drivers or the passengers of the cars, bus or trucks.

One of the ways to overcome such shortcomings is to have resting arrangement that may be applicable and used in the vehicles, such as along the seats of the vehicles. In this regard, there has been various attempt in past. The prior art has put forth several designs for vehicle seat. Among these are:

U.S. Pat. No. 2,772,423 to S. LNDEN describes a combination bassinet and car bed which will stand at normal height when used indoors and may be placed between the front and back seats of a car without taking up the back seat or the space normally required for the knees of one sitting in the back seat.

U.S. Pat. No. 3,570,024 to J. P. GRIFFIN describes a portable car bed of the type which is adapted to transform a seat and adjacent leg area of a car into a bed area. This portable car bed is particularly suited for transforming the back-seat area of a sedan-type car into a bed area.

U.S. Pat. No. 4,232,413 to Mongault describes a device permitting to the use of the rear seats of a vehicle as cots.

However, none of the above-stated prior art references describe the way present invention describes foldable bed for vehicle.

### SUMMARY OF THE INVENTION

In view of the foregoing disadvantages inherent in the prior art, the general purpose of the present invention is to provide a foldable bed for a vehicle to include all advantages of the prior art, and to overcome the drawbacks inherent in the prior art.

In one aspect of the present invention, a foldable bed for a vehicle ‘V’ having a front seat ‘S’ is provided. The foldable bed may include a foldable frame, a platform and a plurality of legs configured to each other. The foldable frame may include a plurality of frame parts, and a plurality of latching mechanism may be coupled to the plurality of frame parts. The plurality of latching mechanism may be adapted to be latched to the plurality of frame parts to horizontally extend the plurality of frame parts over the front seat at an inclined position. Further, the plurality of latching mechanism may be adapted to be de-latched to fold the plurality of frame parts to be stored in the vehicle. Further, the platform may be disposed over the foldable frame. The platform may be adapted to receive a vehicle passenger or a user for relaxing thereover. Furthermore, the plurality of legs may be attached to the foldable frame. The plurality of legs may extent below the foldable frame to support the plurality of frame parts at horizontally extended position over the front seat at the inclined position thereof.

In one embodiment, the plurality of frame parts of the foldable frame 110 may include frame parts.

In one embodiment, the plurality of frame parts of the foldable frame 110 may be of metallic material.

In one embodiment, the plurality of frame parts of the foldable frame 110 may be foldable one below another.

In one embedment, each of the plurality of latching mechanism may couple two adjoining frame parts and of the plurality of frame parts.

In one embodiment, each of the plurality of latching mechanism may include a latching frame, and a latching support engaged to the latching frame. The latching frame may be coupled to at least two adjoining frame parts of the plurality of frame parts to support the two adjoining frame parts. Further, the latching support may be engaged to the latching frame to hold the latching frame at a position for holding the horizontally extended plurality of frame parts over the front seat at the inclined position.

In one embodiment, the platform may include mattress or webbing of a fabric material disposed thereover.

In one embodiment, the platform may be non-foldable and non-inflatable. In such embodiment, the non-foldable and non-inflatable platform may be disposed over the foldable platform at the horizontally extended position of plurality of frame parts. The non-foldable and non-inflatable platform may be disengaged from the foldable platform at a folded position.

In one embodiment, the platform may be foldable and non-inflatable. In such embodiment, the foldable and non-inflatable platform may be disposed over the foldable platform to be horizontally extended with the plurality of frame parts, and be folded with the plurality of frame parts at a folded position of the plurality of frame parts.

In one embodiment, the plurality of legs may include four legs spaced part and detachably attached to the foldable frame across sides thereof to extent below the foldable frame in such a manner that the inclined front seat of the vehicle is aligned within the four legs.

In one embodiment, the plurality of legs may be at an inclined position with respect to the foldable frame.

In one embodiment, the plurality of legs may include an adjustable mechanism to adjust the length of the plurality of legs as per the user or the vehicle passenger need.

In one embodiment, the plurality of legs may be attached to the foldable frame via a hinge mechanism.

In one embodiment, the plurality of legs may be of metallic material.

In one further aspect of the present invention, a method for using a foldable bed in a vehicle ‘V’ having a front seat ‘S’ may be provided. The method includes placing a foldable frame over an inclined position of the front seat ‘S’. The foldable frame may include a plurality of frame parts, and a plurality of latching mechanism coupled to the plurality of frame parts, a platform disposed over the foldable frame, a plurality of legs attached to the foldable frame. The method further includes, horizontally extending the plurality of frame parts over the front seat at the inclined position thereof. Further, latching the horizontally extending plurality of frame parts; and supporting the plurality of frame parts at the horizontally extended position over the front seat at the inclined position thereof such that the inclined front seat of the vehicle is aligned within the plurality of legs.

The method further includes de-latching the horizontally extending plurality of frame parts to fold the plurality of frame parts to be stored in the vehicle.

In one further aspect of the present invention, a foldable bed may be provided. The foldable bed may include a foldable frame, a platform and a plurality of legs configured to each other. The foldable frame may include a plurality of frame parts, and a plurality of latching mechanism may be coupled to the plurality of frame parts. The plurality of latching mechanism may be adapted to be latched to the plurality of frame parts to horizontally extend the plurality of frame parts over the front seat at an inclined position. Further, the plurality of latching mechanism may be adapted to be de-latched to fold the plurality of frame parts to be stored. Further, the platform may be disposed over the foldable frame. The platform may be adapted to receive a vehicle passenger or a user for relaxing thereover. Furthermore, the plurality of legs may be attached to the foldable frame. The plurality of legs may extent below the foldable frame to support the plurality of frame parts at horizontally extended position over the front seat at the inclined position thereof.

This together with the other aspects of the present invention, along with the various features of novelty that characterize the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a side view of an environment where a foldable bed is shown in utilized state with an inclined car seat of a car, in accordance with an embodiment of the present invention;

FIG. 2A illustrates a top view of a foldable bed, preferably showing a platform and a foldable frame, in accordance with an embodiment of the present invention;

FIGS. 2B and 2C illustrate a side view of the foldable bed, wherein legs there are in folded state, in accordance with various embodiment of the present invention;

FIG. 3A illustrates an angular view, preferably 30 degrees view, of a platform, in accordance with various embodiment of the present invention;

FIG. 3B illustrates a side view of the foldable bed wherein legs are in extended state, in accordance with various embodiment of the present invention;

FIG. 4 illustrates a bottom view of the platform depicting latching mechanism, in accordance with various embodiment of the present invention; and

FIG. 5 illustrates a flow diagram indicating a method for using the foldable seat, in accordance with various embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms, “a” and “an” herein do not denote a limitation of quantity, but rather denote the presence of at least one of the referenced items.

In one aspect of the present invention, a foldable bed for a vehicle ‘V’ having a front seat ‘S’ is provided. The foldable bed may include a foldable frame, a platform and a plurality of legs configured to each other. The foldable frame may include a plurality of frame parts, and a plurality of latching mechanism may be coupled to the plurality of frame parts. The plurality of latching mechanism may be adapted to be latched to the plurality of frame parts to horizontally extend the plurality of frame parts over the front seat at an inclined position. Further, the plurality of latching mechanism may be adapted to be de-latched to fold the plurality of frame parts to be stored in the vehicle. Further, the platform may be disposed over the foldable frame. The platform may be adapted to receive a vehicle passenger or a user for relaxing thereover. Furthermore, the plurality of legs may be attached to the foldable frame. The plurality of legs may extent below the foldable frame to support the plurality of frame parts at horizontally extended position over the front seat at the inclined position thereof.

In one further aspect of the present invention, a method for using a foldable bed in a vehicle ‘V’ having a front seat ‘S’ may be provided. The method includes placing a foldable frame over an inclined position of the front seat ‘S’. The foldable frame may include a plurality of frame parts, and a plurality of latching mechanism coupled to the plurality of frame parts, a platform disposed over the foldable frame, a plurality of legs attached to the foldable frame. The method further includes, horizontally extending the plurality of frame parts over the front seat at the inclined position thereof. Further, latching the horizontally extending plurality of frame parts; and supporting the plurality of frame parts at the horizontally extended position over the front seat at the inclined position thereof such that the inclined front seat of the vehicle is aligned within the plurality of legs. The method further includes de-latching the horizontally extending plurality of frame parts to fold the plurality of frame parts to be stored in the vehicle.

In one further aspect of the present invention, a foldable bed may be provided. The foldable bed may include a foldable frame, a platform and a plurality of legs configured to each other. The foldable frame may include a plurality of frame parts, and a plurality of latching mechanism may be coupled to the plurality of frame parts. The plurality of latching mechanism may be adapted to be latched to the plurality of frame parts to horizontally extend the plurality of frame parts over the front seat at an inclined position. Further, the plurality of latching mechanism may be adapted to be de-latched to fold the plurality of frame parts to be stored. Further, the platform may be disposed over the foldable frame. The platform may be adapted to receive a vehicle passenger or a user for relaxing thereover. Furthermore, the plurality of legs may be attached to the foldable frame. The plurality of legs may extent below the foldable frame to support the plurality of frame parts at horizontally extended position over the front seat at the inclined position thereof.

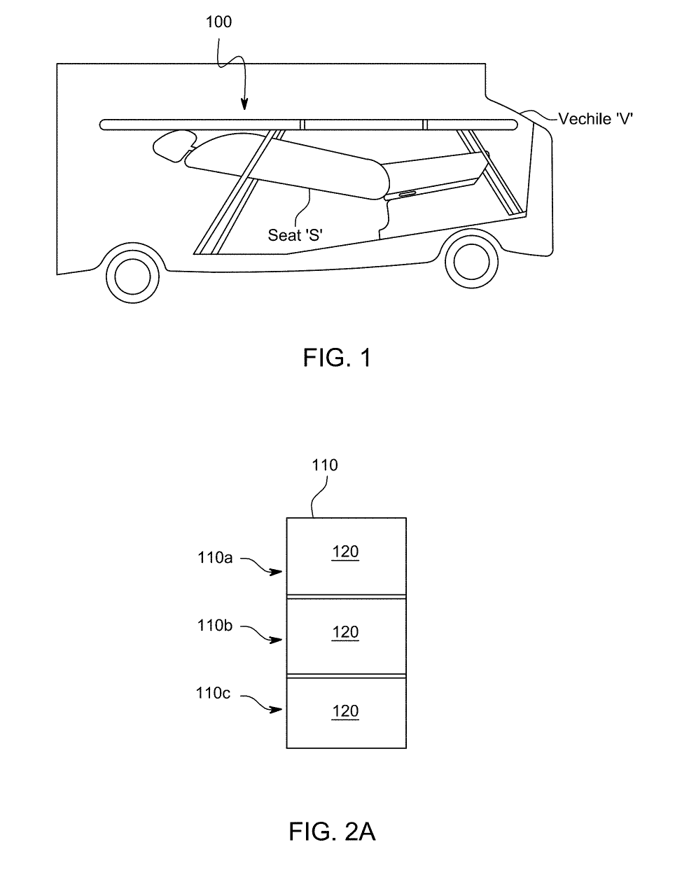

Referring now to FIG. 1 to FIG. 4, a foldable bed 100 will be described in accordance to an exemplary embodiment of the present disclosure. As shown in FIG. 1, a side view of an environment where the foldable bed 100 is shown in utilized state with a vehicle ‘V’, specifically with a front seat ‘S’ in an inclined state thereof to facilitate sleeping of a user of the foldable bed, in accordance with an embodiment of the present disclosure. The environment of FIG. 1 is shown as an example purpose and that the foldable bed 100 may not configured to be limiting only to the depicted environment of the vehicle ‘V’ and the front seat ‘S’ of the vehicle ‘V’. The foldable bed 100 may be utilized in various environment, for example, the foldable bed 100 may be employed to sleep on in the back of a truck; the foldable bed 100 may be employed to sleep on in a tent; the foldable bed 100 may be employed to sleep on in a boat; the foldable bed 100 may be employed as an emergency guest bed; the foldable bed 100 may be employed with a sleeping bag thus eliminating additional bed clothing; or the foldable bed 100 may be employed to transport injured or medical sick patients, who cannot sit upright, to and from the hospital in a car.

The foldable bed 100 may be along with the environment of the vehicle ‘V’ and the front seat ‘S’ of the vehicle ‘V’ will be described herein for better understanding of the invention, and as mentioned shall not consider to be limiting only to this environment.

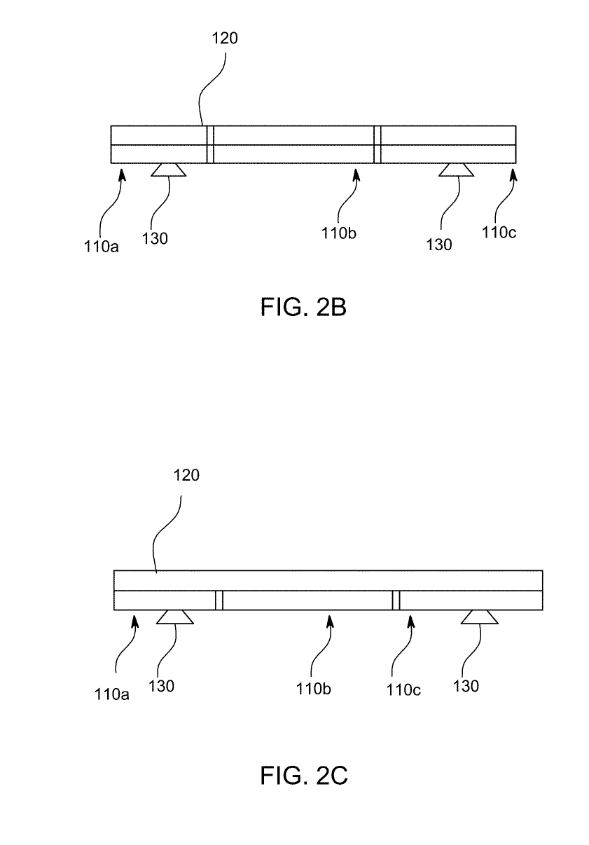

As shown in FIG. 2A to 4, the foldable bed 100 may include a foldable frame 110, a platform 120 and a plurality of legs 130. The platform 120 may be disposed over the foldable frame 110. The platform 120 may be adapted to receive a vehicle passenger or a user for relaxing thereover. The plurality of legs 130 may be attached to the foldable frame 110. The plurality of legs 130 may extent below the foldable frame 110 to support thereto.

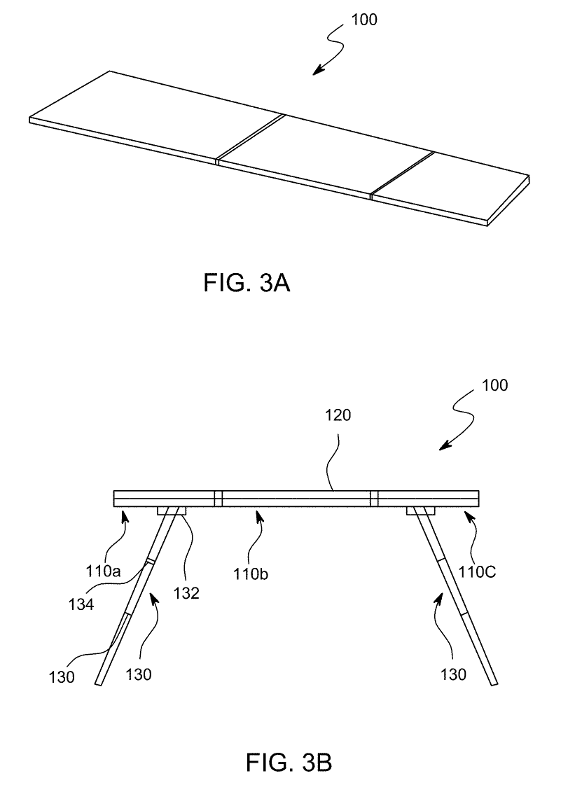

The foldable frame 110 may include a plurality of frame parts. As shown in FIGS. 2A to 3B, there are shown three frame parts, such as, the frame parts 110a, 110b and 110c. However, without departing from the scope of the present disclosure, there may be more than or less than three frame parts, as per the requirement of the user. The number of frame parts shall not consider to be limiting to what is disclosed in the drawings. Further, the plurality of frame parts 110a, 110b and 110c of the foldable frame 110 may be foldable in various form, in one example, the plurality of frame parts 110a, 110b and 110c of the foldable frame 110 may be foldable one below another. Furthermore, the plurality of frame parts 110a, 110b and 110c of the foldable frame 110 may be made of various types of material. In one example, the plurality of frame parts of the foldable frame 110 may be made of metallic material.

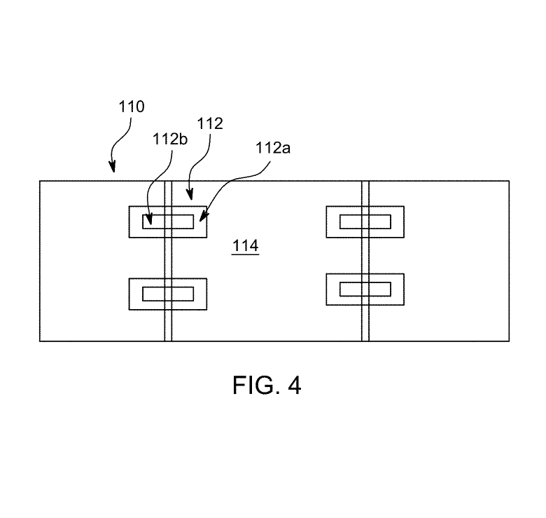

The foldable frame 110 may further include a plurality of latching mechanism 112, as shown in FIG. 4, that may be coupled to the plurality of frame parts 110a, 110b and 110c, along a bottom side 114 of the foldable frame 110. The plurality of latching mechanism 112 may be adapted to be latched to the plurality of frame parts 110a, 110b and 110c to horizontally extend the plurality of frame parts 110a, 110b and 110c over the front seat ‘S’ at an inclined position. Further, the plurality of latching mechanism 112 may be adapted to be de-latched to fold the plurality of frame parts 110a, 110b and 110c to be stored in the vehicle.

In one embedment, each of the plurality of latching mechanism 112 may couple two adjoining frame parts 110a and 110b, and 110b and 110c of the plurality of frame parts.

For such adjoining of the frame parts 110a and 110b, and 110b and 110c, in one embodiment, each of the plurality of latching mechanism 112 may include a latching frame 112a, and a latching support 112b engaged to the latching frame 112a. As shown, the latching frame 112a may be coupled to at least two adjoining frame parts, such as parts 110a and 110b, of the plurality of frame parts to support the two adjoining frame parts 110a and 110b. Further, the latching support 112b may be engaged to the latching frame 112a to hold the latching frame at a position for holding the horizontally extended plurality of frame parts 110a, 110b and 110c over the front seat ‘S’ at the inclined position.

Further, the platform 120 may be disposed over the foldable frame 110. The platform 120 may be adapted to receive the vehicle passenger or the user for relaxing thereover. The platform 120 may include mattress or webbing of a fabric material disposed thereover. In one embodiment, the platform 120 may be non-foldable and non-inflatable. In such embodiment, as shown in FIG. 2C, the non-foldable and non-inflatable platform 120 may be disposed over the foldable platform 110 at the horizontally extended position of plurality of frame parts 110a, 110b and 110c. The non-foldable and non-inflatable platform 120 may be disengaged from the foldable platform at a folded position of the foldable platform. In one further embodiment, as shown in FIG. 2B, the platform 120 may be foldable and non-inflatable. In such embodiment, the foldable and non-inflatable platform 120 may be disposed over the foldable platform to be horizontally extended with the plurality of frame parts 110a, 110b and 110c, and be folded with the plurality of frame parts 110a, 110b and 110c at a folded position of the plurality of frame parts 110a, 110b and 110c. The foldable frame 110 and the platform 120 are supported by the plurality of legs 130.

As shown in FIG. 3B, the plurality of legs 130 may be attached to the foldable frame 110. The plurality of legs 130 may extent below the foldable frame 110 to support the plurality of frame parts 110a, 110b and 110c at horizontally extended position over the front seat ‘S’ at the inclined position thereof. In one embodiment, the plurality of legs 130 may include four legs, as seen in FIG. 1, spaced part and detachably attached to the foldable frame 110 across sides thereof to extent below the foldable frame 110 in such a manner that the inclined front seat ‘S’ of the vehicle is aligned within the four legs. In one embodiment, the plurality of legs 130 may be attached to the foldable frame 110 via a hinge mechanism 132, as seen in FIG. 3. In one embodiment, the plurality of legs 130 may be at an inclined position with respect to the foldable frame 110. However, without departing from the scope of the present disclosure, the plurality of legs 130 may be at right angled with respect to the foldable frame 110.

In one embodiment, the plurality of legs 130 may be adjustable. Such leg 130 may include an adjustable mechanism 134 to adjust the length of the plurality of legs as per the user or the vehicle passenger need. The adjustable mechanism 134 may be a telescopic arrangement. The plurality of legs 130 may be made of various types of material. In one example, the plurality of legs 130 may be made of metallic material.

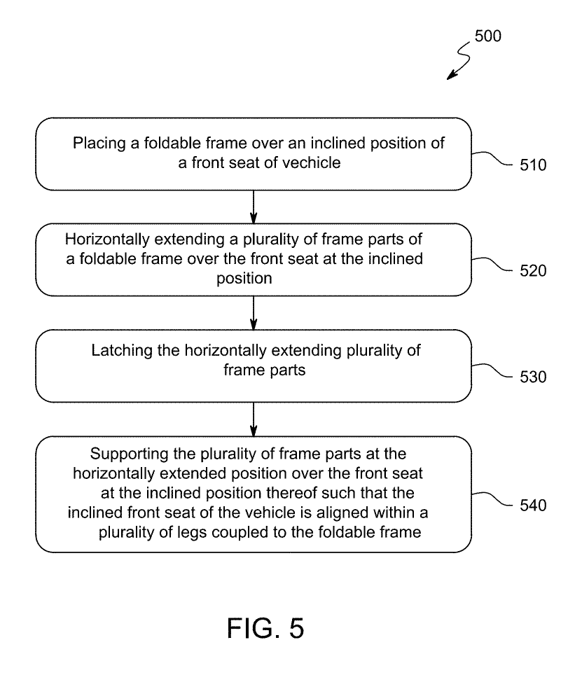

Reference will now be made to FIG. 5, which illustrate a flow diagram indicating a method 500 for using the foldable bed 100, in accordance with various embodiment of the present invention.

The method 500 for using the foldable bed 100 in the vehicle ‘V’ having the front seat ‘S’ may be provided. The method 500 at 510 includes placement of the foldable frame 110 over the inclined position of the front seat ‘S’. Further, at 520, the method includes, extending the plurality of frame parts 110a, 110b and 110c horizontally over the front seat ‘S’ at the inclined position thereof. Further, at 530, the horizontally extended frame parts 110a, 110b and 110c are latched using the latching mechanism 140. The method 500, at 540, supports the plurality of frame parts 110a, 110b and 110c at the horizontally extended position over the front seat at the inclined position thereof such that the inclined front seat of the vehicle is aligned within the plurality of legs 130.

In one embodiment, the method 500 may further, include de-latching the horizontally extending plurality of frame parts 110a, 110b and 110c to fold the plurality of frame parts 110a, 110b and 110c to be stored in the vehicle.

The present invention provides a foldable bed, such as the foldable bed 100, which offers the various advantages. The foldable bed 100 of the present invention is for a vehicle having a front seat, and that the foldable bed may be placed over the front seat at its inclined position. The foldable bed 100 may be utilized in various environment, for example, the foldable bed 100 may be employed to sleep on in the back of a truck; the foldable bed 100 may be employed to sleep on in a tent; the foldable bed 100 may be employed to sleep on in a boat; the foldable bed 100 may be employed as an emergency guest bed; the foldable bed 100 may be employed with a sleeping bag thus eliminating additional bed clothing; or the foldable bed 100 may be employed to transport injured or medical sick patients, who cannot sit upright, to and from the hospital in a car. Further, the foldable bed 100 is a cost-effective solution to frequent travelers, providing them a provision to comfortably sleep in the vehicle and excluding the need of booking expensive motels.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A foldable bed for a vehicle having a front seat, the foldable bed comprising:
a foldable frame having
a plurality of frame parts, and
a plurality of latching mechanism coupled to the plurality of frame parts,
wherein the plurality of latching mechanism is adapted to be latched to the plurality of frame parts to horizontally extend the plurality of frame parts over the front seat at an inclined position, and
wherein the plurality of latching mechanism is adapted to be de-latched to fold the plurality of frame parts to be stored in the vehicle;
a platform disposed over the foldable frame, the platform adapted to receive a vehicle passenger or a user for relaxing thereover; and
a plurality of legs attached to the foldable frame, the plurality of legs extent below the foldable frame to support the plurality of frame parts at horizontally extended position over the front seat at the inclined position thereof.

2. The foldable bed of claim 1, wherein the plurality of frame parts of the foldable frame comprises three frame parts.

3. The foldable bed of claim 1, wherein the plurality of frame parts of the foldable frame is of metallic material.

4. The foldable bed of claim 1, wherein the plurality of frame parts of the foldable frame are foldable one below another.

5. The foldable bed of claim 1, wherein each of the plurality of latching mechanism couples two adjoining frame parts of the plurality of frame parts.

6. The foldable bed of claim 5, wherein each of the plurality of latching mechanism comprises:
a latching frame coupled to at least two adjoining frame parts of the plurality of frame parts to support the two adjoining frame parts; and
a latching support engaged to the latching frame to hold the latching frame at a position for holding the horizontally extended plurality of frame parts over the front seat at the inclined position.

7. The foldable bed of claim 1, wherein the platform comprises mattress or webbing of a fabric material disposed thereover.

8. The foldable bed of claim 1, wherein the platform is non-foldable and non-inflatable,
wherein the non-foldable and non-inflatable platform is disposed over the foldable platform at the horizontally extended position of plurality of frame parts, and wherein the non-foldable and non-inflatable platform is disengaged from the foldable platform at a folded position.

9. The foldable bed of claim 1, wherein the platform is foldable and non-inflatable,
wherein the foldable and non-inflatable platform is disposed over the foldable platform to be horizontally extended with the plurality of frame parts, and be folded with the plurality of frame parts at a folded position of the plurality of frame parts.

10. The foldable bed of claim 1, wherein the plurality of legs comprises four legs spaced part and detachably attached to the foldable frame across sides thereof to extent below the foldable frame in such a manner that the inclined front seat of the vehicle is aligned within the four legs.

11. The foldable bed of claim 1, wherein the plurality of legs are at an inclined position with respect to the foldable frame.

12. The foldable bed of claim 1, wherein the plurality of legs comprises an adjustable mechanism to adjust the length of the plurality of legs as per the user or the vehicle passenger need.

13. The foldable bed of claim 1, wherein the plurality of legs are attached to the foldable frame via a hinge mechanism.

14. The foldable bed of claim 1, wherein the plurality of legs is of metallic material.

15. A method for using a foldable bed in a vehicle having a front seat, the method comprising:
placing a foldable frame over an inclined position of the front seat, the foldable frame having
a plurality of frame parts and a plurality of latching mechanism coupled to the plurality of frame parts,
a platform disposed over the foldable frame,
a plurality of legs attached to the foldable frame,
horizontally extending the plurality of frame parts over the front seat at the inclined position thereof;
latching the horizontally extending plurality of frame parts; and
supporting the plurality of frame parts at the horizontally extended position over the front seat at the inclined position thereof such that the inclined front seat of the vehicle is aligned within the plurality of legs.

16. The method of claim 15 further comprises de-latching the horizontally extending plurality of frame parts to fold the plurality of frame parts to be stored in the vehicle.

17. A foldable bed comprising:
a foldable frame having a plurality of frame parts and a plurality of latching mechanism coupled to the plurality of frame parts, wherein the plurality of latching mechanism is adapted to be latched to the plurality of frame parts to horizontally extend the plurality of frame parts, and wherein the plurality of latching mechanism is adapted to be de-latched to fold the plurality of frame parts to be stored in a vehicle;
a platform disposed over the foldable frame, the platform adapted to receive a user for relaxing thereover; and
a plurality of legs attached to the foldable frame, the plurality of legs extent below the foldable frame to support the plurality of frame parts at horizontally extended position.

18. The foldable bed of claim 17, wherein each of the plurality of latching mechanism couples two adjoining frame parts of the plurality of frame parts, wherein each of the plurality of latching mechanism comprises:
a latching frame coupled to at least two adjoining frame parts of the plurality of frame parts to support the two adjoining frame parts; and
a latching support engaged to the latching frame to hold the latching frame at a position for holding the horizontally extended plurality of frame parts.

19. The foldable bed of claim 17, wherein the plurality of legs are attached to the foldable frame via a hinge mechanism.

20. The foldable bed of claim 17, wherein the plurality of legs comprises an adjustable mechanism to adjust the length of the plurality of legs as per the user's need.
